(19) United States
(12) Patent Application Publication
(10) Pub. No.: US 2002/0130013 A1
(43) Pub. Date: Sep. 19, 2002

(54) APPARATUS FOR TRANSPORT OF PARTS OF A WORKPIECE

(76) Inventor: ERICH HARSCH, WEINGARTEN (DE)

Correspondence Address: MORGAN LEWIS & BOCKIUS LLP, 1111 PENNSYLVANIA AVENUE NW, WASHINGTON, DC, 20004, US

(21) Appl. No.: 09/405,137

(22) Filed: Sep. 24, 1999

(30) Foreign Application Priority Data
Sep. 28, 1998 (DE) 298 17 208.9
Nov. 5, 1998 (DE) 298 19 775.8

(51) Int. Cl. B65G 1/00

(52) U.S. Cl. 198/468.6

(57) ABSTRACT

The invention proposes an apparatus which is intended for transporting workpiece parts, in particular, following the forming stages of a large-part multiple die press and in the case of which a conveying apparatus (10) is equipped with parts racks (14, 15) which serve for the defined positioning of, and for transporting, the workpieces during transportation and removal.

The invention relates to an apparatus for transporting workpiece parts according to the preamble of claim 1.

### PRIOR ART

In so-called large-part multiple die presses, workpieces are processed in a multiplicity of forming stations. The transportation within the press takes place, for example, by means of a suction bar or by means of grippers. Following the last processing stage, the workpiece parts, in completed form, are removed from the press and fed to a destacking apparatus. A rack for workpiece parts in a non-productive stage, which is provided after the last processing stage, of such a large-part multiple die press is described in EP 0 423 749. DE 32 36 145 A1 describes an apparatus for setting down the workpieces following the last processing stage. In the case of this apparatus, the workpieces which are removed from the press are fed to a stacking installation by means of a finished-part conveyor designed as a conveying belt.

A similar apparatus is disclosed in the publication in the journal “Werkstatt und Betrieb 119 (1986) 5”, Pages 355 to 357. In this publication, the workpieces are separated in the last operation and set down in position on a rack by double gripping tongs. With the aid of a part-specific frame which is equipped with a vacuum sucker, the workpieces are shifted from said rack onto a cyclic conveyor during the next unloading displacement. Said conveyor brings the parts in a stepwise manner into the operating region of an industrial robot. The industrial robot is equipped with a vacuum suction frame in order to receive the workpieces. These are then set down in ordered layers in a centered transporting container.

The conventional transportation of finished parts on conveying belts or cyclic conveyors, for example, to the removal robot appears straightforward when the parts transported in this way are dimensionally stable and easy to handle. Modern-day large-part multiple-die presses, however, produce extremely large parts which have, for example, a low drawing depth and/or a large number of cutouts and thus overall, in terms of their handling, tend to act as unstable rather than stable workpieces. In any case, transportation of such parts on a conventional conveying belt entails problems with the subsequent handling.

### OBJECT AND ADVANTAGES OF THE INVENTION

The object of the invention is to propose an apparatus which is intended for transporting workpiece parts and is suitable, in particular, for handling large-surface-area parts from a large-part multiple die press.

This object is achieved by the features of patent claim 1. Advantageous and expedient developments of the apparatus according to patent claim 1 are specified in the subclaims.

The invention proposes an advantageous removal system, following a large-part multiple die press, with very reliable transportation, in particular, of unstable parts even at a high cycle speed, in order that said parts can be destacked subsequently without surface quality being impaired.

The invention provides, in particular, that, once they have run through the press, the workpieces are positioned on a conveying apparatus, preferably designed as a cyclic conveyor, special part-specific guide plates being provided so that the workpiece can be set down thereon, in order to achieve defined positioning of the workpieces. As a result, in particular unstable workpieces are positioned, and transported, in a defined manner. Accordingly, such guide-plate-aided positioning on a cyclic conveyor has the advantage that even sensitive parts can be handled without difficulties.

The guide plates for the cyclic conveyor can be exchanged automatically in order to be adapted to different workpieces.

The apparatus according to the invention, is suitable, in particular for very large parts, for example car or minibus roofs, and side parts or floor panels for such vehicles. However, it can also be used for medium-sized double parts, for example left-hand and right-hand car doors.

The transportation of the optimally positioned and correctly supported parts, for example, to a removal robot advantageously takes place in that the guide plates can be lowered by means of a production spindle, as a result of which the parts come to rest on a parts rack, located therebeneath, of a transporting apparatus, e.g. of a transporting carriage. Said parts rack receives the workpiece and transports the same, in a transporting step, to the following transporting stage within the cyclic conveyor. This transporting stage may be, for example, a control stage or the end, removal stage.

In a manner similar to a so-called shuttle, a carriage which moves back and forth receives the parts on a special parts rack and conveys them cyclically to the next transporting stage. As a result, the part also passes in the correct position into the last transporting stage, from which it is received in the correct position by the industrial robot and set down into a stacking magazine.

The proposed arrangement also achieves very short paths to the stacking location, which renders the transportation more reliable and results in smaller overall length for the installation.

It is also possible for the operation of equipping the removal robot with a multi-arm suction means to take plate automatically. As a result, the various transporting apparatuses can be adapted to the different workpiece conditions.

Further details and advantages of the invention can be gathered from the exemplary embodiments which are explained hereinbelow with reference to the drawings, in which:

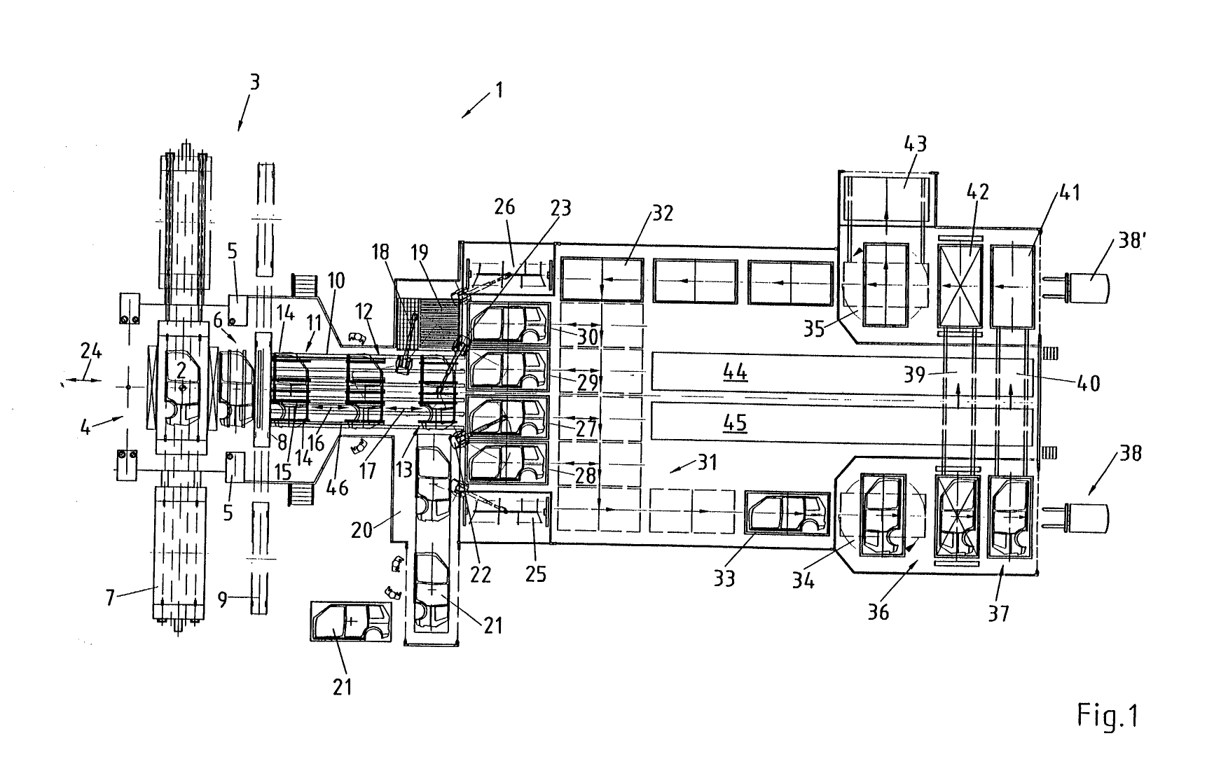

FIG. 1 shows a plan view of an apparatus according to the invention which is intended for automatically destacking side parts and has a shuttle apparatus and robot.

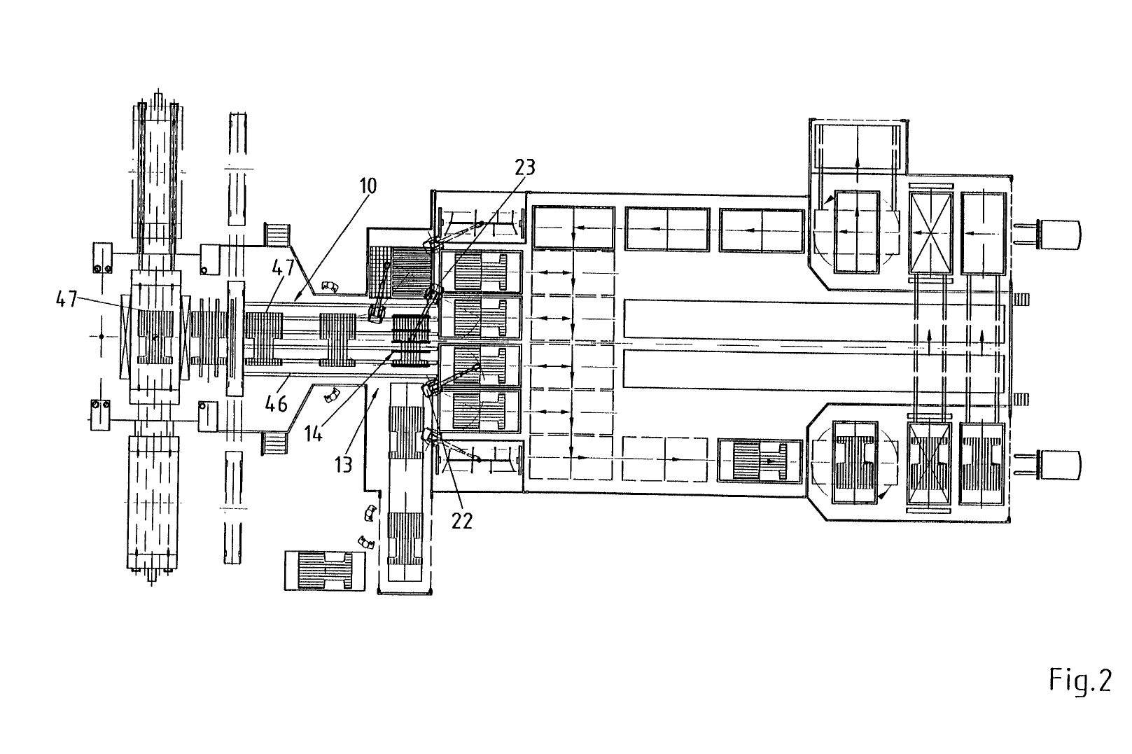

FIG. 2 shows a modified apparatus according to FIG. 1 for automatically destacking floor panels and

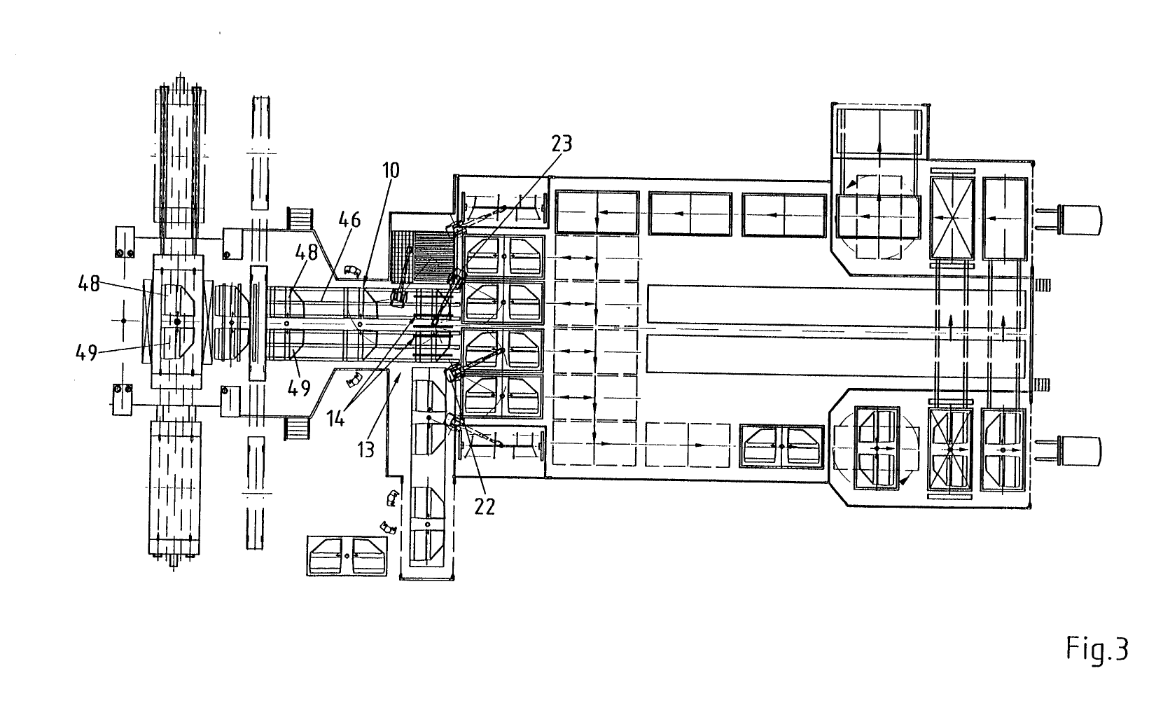

FIG. 3 shows a modification according to FIG. 1 which is intended for automatically destacking double parts and has a three-track double belt and robot for removing the parts.

### DESCRIPTION OF THE EXEMPLARY EMBODIMENTS

The apparatus 1 illustrated in FIG. 1 serves for automatically destacking workpiece parts 2 which were designed, for example, as side parts for a minibus. FIG. 1 shows the rear end of a large-part multiple die press 3 with the last forming station 4 and a last non-productive stage 6 of the press, said non-productive stage being arranged between the press columns 5. Sliding table 7 serve for exchanging, inter alia the tools of the forming station 4. The carriages 9 for the guide-plates carriers of the last forming stage are removed via a removal station 8.

The workpiece-transporting system of the press transfer means transports the workpiece 2 by a suction-bar transfer means or a gripper-rail transfer means, in a so-called half transporting step, from the last forming station 4 to the following, non-productive stage 6 and from there, in a similar transporting step, into the first setting-down station 11 of a cyclic conveyor 10, which is arranged downstream of the press. In this case, in its first setting-down stage 11, the cyclic conveyor 10 has special guide plates 14 which allow defined positioning for the relatively unstable workpiece. Such a cyclic conveyor is also referred to as a shuttle.

The defined positioning of the unstable parts is necessary because, on account of their size and of their low drawing depth, these parts require defined support. Straightforward positioning on a transporting belt would result in an undefined setting-down operation.

The parts are transported within the cyclic conveyor 10 to the following transporting stages 12, 13 by means of a further transporting apparatus 16, 17, these transporting apparatuses merely being indicated and being designed, for example, as displaceable transporting carriages (shuttle apparatus). In this case, the displaceable carriages themselves are equipped with their own parts rack 15, on which the workpieces are set down for transportation purposes (horizontal axis). The transporting carriage has its own drive, e.g. by means of motor and toothed belt, and usually travels over a constant path of displacement.

Provided in each of the three transporting stages 11, 12 and 13 is a stationary, but vertically displaceable parts rack with guide plate 14, with a vertical production spindle and with in each case, for example, 5 rack strips for receiving the guide plates. First of all, the workpieces 2 are set down, by the transporting system of the press, on the guide plates of the upwardly displaced parts rack 14. These parts racks are then displaced downward, with the result that the workpieces pass onto parts racks which can be displaced by the carriages, said displaceable parts racks, for their part, having fixed exchangeable-parts receiving means. In this case, the exchangeable parts can be introduced manually or automatically, as guide plate, on the stationary and on the displaceable parts racks. For automatically changing over the exchangeable parts, that is to say the guide plates, a separate robot 18 removes the necessary exchangeable parts from a magazine 19.

Furthermore, the magazine 19 may have spacer elements which are positioned on the workpieces by the robot 18 in order to space the unstable parts apart from one another and, if appropriate, to protect the surface.

The central transporting stage 12 serves as a control stage. Accordingly, the third transporting stage 13 is assigned an ejecting path 20 for rejects or control parts 21.

The transfer of the workpieces for transportation from stage 12 to stage 13 takes place by lowering of the stationary parts rack and thus positioning on the parts rack of the displaceable carriages as has already been described.

The third transporting stage 13 is assigned two robots 22, 23, which can be displaced transversely to the longitudinal direction 24 of the press working line. As a result, the robots can remove the necessary multi-arm suction means or gripping apparatuses for the workpiece transportation from laterally arranged exchange magazines 25, 26. The exchange of the multi-arm suction means from the storage area takes place automatically, and for this purpose the robots 22, 23 can be displaced transversely to the transporting direction of the press.

The robots 22, 23 alternately remove the workpieces from the third transporting stage 13 of the cyclic conveyor 10 and set them down in respectively two associated stacking magazines 27, 28 for the robot 22 and 29, 30 for the robot 23. The stacking magazines, which are thus filled in pairs by a robot, are then brought onto a type of circular conveyor 31 which feeds empty stacking magazines 32 and removes full stacking magazines 33. The circular conveyor 31 is assigned, in the bottom branch in FIG. 1, a turning station 34 and, in the top branch; a further turning station 35, in which the respective container carrier is turned through 90°. Arranged downstream of the turning station 34 is a lifting station 36, for stacking two containers, and a further station 37, for the removal, by means of a transporting vehicle 38 of in each case two containers stacked one above the other. The container carriers present in each case are brought from the stations 36, 37, via in each case one transverse conveyor 39, 40, to the container-supply station 41 and/or to the lifting station 42 for the purpose of separating two containers. A transporting vehicle 38′ conveys to the container-supply station 41 two containers which are located emptily [sic] one above the other. In the turning station 35, the containers are inspected, subjected to control checks and, if appropriate, ejected as defective in the station 43.

In the center, there may be provided two additional conveying belts 44, 45, which may be advanced directly up to the cyclic conveyor 10, if appropriate, for manual removal of the parts. For example, the robots 22, 23 may position the parts directly on the conveying belts 44, 45, from where they can be removed manually.

Furthermore, the cyclic conveyor 10 may be provided with an additional belt conveyor 46, which permits combination with a normal conveying belt in the case of appropriate parts.

The robot 18 serves for automatically changing over the exchangeable parts in the parts rack and for feeding parts spacers. For example, for closed, large-surface-area outer-paneling parts, it is possible for foam panels of a certain size to be placed into position for each part.

The other robots 22, 23 serve for turning and conveying the workpieces and for automatically stacking them in containers or, in the case of manual stacking operation, for setting them down on conveying belts. The robots are in a suspended arrangement. Two stations 25, 26 are provided for automatically exchanging the multi-arm suction means for the robots.

In the case of the exemplary embodiment according to FIG. 2, workpieces in the form of a floor panel 47 are handled in an installation of virtually the same design. In this case, the cyclic conveyor 10 is designed as a belt conveyor 46 and has the previously described parts racks 14 only in its third transporting stage 13. Accordingly, the workpiece 47 is transported into the third transporting stage 13 via the belt conveyor 46 and, by means of the vertically displaceable parts rack 14 with appropriate guide plates, the workpiece 47 is aligned in the correct position for specific removal by means of the two robots 22, 23.

The transporting carriages (shuttle) described in FIG. 1 are replaced by the belt conveyor 46 in the case of the exemplary embodiment according to FIG. 2. However, the workpiece is aligned correctly by means of the vertically displaceable parts racks (guide plates) in the transporting position, which is assigned to the robots (22, 23).

Finally, the exemplary embodiment according to FIG. 3 shows a variant of the exemplary embodiment according to FIG. 2, in the case of which the workpiece handled is constituted by two double parts 48, 49 rather than a floor panel 47. In this case, the double parts may likewise be fed to the two robots 22, 23 by means of a belt conveyor 46. In this position or transporting stage 13, once again a stationary, vertically displaceable parts rack 14 is activated for each workpiece 48, 49, in order for the parts to be made available to the robots, for removal purposes, in a precisely positioned manner.

The invention is not restricted to the exemplary embodiment illustrated and described. Rather, it also covers all modifications and variations within the scope of the claims.

| List of designations: | |
|---|---|
| 1 | Apparatus |
| 2 | Workpiece parts |
| 3 | Large-part multiple |
| | die press |
| 4 | Last forming station |
| 5 | Press columns |
| 6 | Non-productive stage |
| 7 | Sliding table |
| 8 | Removal station |
| 9 | Carriage |
| 10 | Cyclic conveyor |
| 11 | Transporting station |
| 12 | Transporting station |
| 13 | Transporting station |
| 14 | Parts rack/guide |
| | plate |
| 15 | Parts rack/guide |
| | plate |
| 16 | Transporting |
| | apparatus |
| 17 | Transporting |
| | apparatus |
| 18 | Robot |
| 19 | Magazine |
| 20 | Ejecting path |
| 21 | Reject/control parts |
| 22 | Robot |
| 23 | Robot |
| 24 | Longitudinal |
| | direction |
| 25 | Magazines |
| 26 | Magazines |
| 27 | Stacking magazines |
| 28 | Stacking magazines |
| 29 | Stacking magazines |
| 30 | Stacking magazines |
| 31 | Course [sic] |
| | conveyor |
| 32 | Stacking magazine |
| 33 | Stacking magazine |
| 34 | Turning station |
| 35 | Turning station |
| 36 | Lifting station |
| 37 | Removal station |
| 38 | Transporting vehicle |
| 39 | Transverse conveyor |
| 40 | Transverse conveyor |
| 41 | Container-supply |
| | station |
| 42 | Lifting station |
| 43 | Station |
| 44 | Conveying belt |
| 45 | Conveying belt |
| 46 | Belt conveyor |
| 47 | Floor panel |
| 48 | Double parts |

1. Apparatus for transporting workpiece parts, in particular, following the forming stages of a large-part multiple die press, transfer press, press working line or the like, characterized in that a conveying apparatus (10) has at least one transporting station (11-13) which has a stationary, vertically displaceable parts rack or guide plate (14).

2. Apparatus according to claim 1, characterized in that the conveying apparatus is designed as a cyclic conveyor (10), with at least two transporting stations (11 to 13) and at least one stationary, vertically displaceable parts rack (14) in at least one transporting station (13).

3. Apparatus according to claim 1 or 2, characterized in that the conveying apparatus is designed as a cyclic conveyor (10), at least two, and in particular three, stationary, vertically displaceable parts racks (14) being provided, and in that at least one displaceable carriage with its own parts rack (15), and in particular two displaceable carriages with their own parts rack (15), is/are provided, these carriages transporting the workpieces to the following transporting stations (12, 13).

4. Apparatus according to one of the preceding claims, characterized in that the stationary, vertically adjustable parts rack (14) can be displaced vertically downward in a transporting station (11 to 13) in order to transfer the workpiece to the parallel, horizontally displaceable parts rack (15) of the transporting carriage between the transporting stations.

5. Apparatus according to one of the preceding claims, characterized in that an end transporting station (13) of the conveying apparatus (10) is assigned at least one robot, and in particular two robots 22, 23, these robots having a parts-receiving apparatus, such as multi-arm suction means, grippers or the like, and serving for removing the workpieces from a parts rack (13) [sic].

6. Apparatus according to one of the preceding claims, characterized in that the conveying apparatus 10 is designed alternatively or cumulatively as a cyclic conveyor with displaceable carriages and/or as a belt conveyor (46).

7. Apparatus according to one or more of the preceding claims, characterized in that the conveying apparatus (10) has three transporting stations (11, 12, 13), with a front, supply station (11), a central, control station (12) and a following, removal station (13).

8. Apparatus according to one of the preceding claims, characterized in that the conveying apparatus (10) with the robot (22, 23) is assigned a following conveying apparatus (31) which serves for feeding empty, and removing full, stacking magazines (32, 33).

9. Apparatus according to one of the preceding claims, characterized in that the magazines (32, 33) can be fed to the installation, and removed therefrom, as containers which are stacked one above the other, lifting stations (36, 42) and/or turning stations (34, 35) serving for handling the full or empty containers.

10. Apparatus according to one of the preceding claims, characterized in that a robot (18) provides for automatic guide-plate changeover.

11. Apparatus according to one of the preceding claims, characterized in that there is provided at least one station (25, 26) with robot for automatically exchanging the multi-arm suction means.
